(19) United States
(12) Patent Application Publication
(10) Pub. No.: US 2022/0099877 A1
(43) Pub. Date: Mar. 31, 2022

(54) LIGHT-GUIDING ARRANGEMENT, IMAGING OPTICAL UNIT, HEAD MOUNTED DISPLAY AND METHOD FOR IMPROVING THE IMAGING QUALITY OF AN IMAGING OPTICAL UNIT

(71) Applicant: tooz technologies GmbH, Aalen (DE)

(72) Inventors: Georg MICHELS, Aalen (DE); Momchil DAVIDKOV, Aalen (DE)

(21) Appl. No.: 17/427,639

(22) PCT Filed: Jan. 20, 2020
(86) PCT No.: PCT/EP2020/051271

§ 371 Date: Jul. 31, 2021

(30) Foreign Application Priority Data
Feb. 1, 2019 (DE) 10 2019 102 586.9

(51) Int. Cl. F21V 8/00; G02B 5/26; G02B 27/01

(52) U.S. Cl. CPC G02B 6/0026; G02B 5/26; G02B 2027/0178; G02B 2027/0112; G02B 27/0172

(57) ABSTRACT

To improve the imaging quality of an imaging optical unit having a light-guiding arrangement for transferring at least one colour channel having a spectral maximum and a spectral bandwidth, the light-guiding arrangement reduces the spectral bandwidth of the at least one colour channel when the at least one colour channel is transferred.

### PRIORITY

This application claims the benefit of German Patent Application No. 10 2019 102 586.9, filed on Feb. 1, 2019, and which is hereby incorporated herein by reference in its entirety.

### FIELD

The present invention relates to a light-guiding arrangement having an optical waveguide for transferring at least one color channel, and in particular for transferring at least one first color channel and one second color channel, wherein the color channels have a respective spectral maximum and a respective spectral bandwidth. Moreover, the invention relates to an imaging optical unit for forming a virtual image of an original image represented on an image generator, and to a head mounted display having such an imaging optical unit.

### BACKGROUND

Light-guiding arrangements of the type mentioned in the introduction can be used in head mounted displays and in particular in smartglasses. Smartglasses within the meaning of the present description are a special form of a head mounted display which is able to combine electronic images with the directly perceived image of the surroundings and thus to present the user with an electronic image, without preventing direct perception of the surroundings. When combining the electronic images with the directly perceived image of the surroundings, a distinction is drawn essentially between the following principles on which the combining can be based:
1. Using normal spectacles with a beam combiner (e.g. beam splitter cube) attached at the front.
2. Directly coupling in the light from the side, from the top or from the bottom by way of a reflection at the inner side of the spectacle lens, wherein diffraction gratings, Fresnel elements or the like are used in a supporting manner.
3. Guiding the light of the electronic image by means of reflection, in particular by means of total reflection, in the spectacle lens and combining the beam path of the electronic image with the direct image of the surroundings with the aid of an output coupling structure arranged in the spectacle lens and serving for coupling the beam path of the electronic image out of the spectacle lens in the direction of the eye.

Although the first principle functions very well optically, it has only very low social acceptance since the beam combiner attached at the front is outwardly very conspicuous and large. Moreover, the spectacles become front-heavy as a result. The second principle can be realized only with a greatly increased distance between spectacles and head, which is likewise unacceptable. Therefore, the more promising approaches proceed from the third principle, that is to say guiding light in the spectacle lens as an optical waveguide. In this case, the output coupling structure can be configured as a diffraction grating, as a partly transparent inclined mirror or in the form of partly transparent Fresnel elements. In the case of a diffraction grating, the beam path of the electronic image is coupled out from the spectacle lens e.g. via the first-order diffraction maximum, while via the zero-order diffraction maximum the observation light can pass through the output coupling structure with as little impairment as possible. Examples of smartglasses in which the light of the electronic image is guided by means of reflection, in particular by means of total internal reflection, in the spectacle lens to an output coupling structure are described for example in the documents DE 10 2013 207 257 A1, DE 10 2013 223 963 A1, DE 10 2013 223 964 B3, DE 10 2015 117 557 A1, DE 10 2016 124 538 A1, US 2006/0126181 A1, US 2010/0220295 A1 and US 2012/0002294 A1.

The smartglasses are intended to be able to present in particular color electronic images as well. The imaging optical unit of which the optical waveguides are part is therefore usually optimized for a few specific wavelengths, for example for a wavelength in the red spectral range, a wavelength in the green spectral range and a wavelength in the blue spectral range. That is to say that the input coupling structure for coupling into the optical waveguide, the output coupling structure for coupling out of the optical waveguide and the reflections of the imaging beam path within the optical waveguide are optimized with regard to these specific wavelengths.

However, a polychromatic image generator, that is to say an image generator that can generate a color image, does not just emit at the three specific wavelengths for which the imaging optical unit is optimized, but rather in three wavelength ranges, e.g. in a red, a green and a blue wavelength range, each of which has a spectral width. The three specific wavelengths for which the imaging optical unit is optimized are then typically chosen such that they correspond to the spectral maxima of the wavelength ranges or are close to the respective spectral maximum. The spectral bandwidth of the wavelength ranges in which a polychromatic image generator emits results in deteriorations in the imaging quality on account of the optimization of the imaging optical unit to the small number of specific wavelengths.

### SUMMARY

It is therefore an object of certain embodiments of the present invention to provide a light-guiding arrangement, an imaging optical unit and a head mounted display which yield a high imaging quality even together with polychromatic image generators. Moreover, it is an object of certain embodiments of the present invention to provide a method for improving the imaging quality of an imaging optical unit when transferring color channels having a spectral bandwidth.

A light-guiding arrangement according to certain embodiments comprises an optical waveguide for transferring at least one color channel having a spectral maximum and a spectral bandwidth. In particular, however, the optical waveguide can be embodied as an optical waveguide for transferring at least one first color channel and one second color channel, wherein the color channels have a respective spectral maximum and a respective spectral bandwidth and wherein the positions of the spectral maxima in the spectrum differ from one another. The optical waveguide is typically configured for transferring three color channels of this kind. According to the invention, the light-guiding arrangement comprises a device for reducing the spectral bandwidth of the color channel or for reducing the spectral bandwidth of the color channels in the case of at least two color channels. In the context of the present description, an optical waveguide should be considered to encompass any element composed of a transparent material which transports light in its interior, for example by way of total internal reflection at outer surfaces or internal material interfaces of the element. However, the reflection can also be effected at partly or completely reflective layers, instead of by means of total reflection. In the context of the present description, a color channel is considered to be in particular a primary color of a color space used for generating a polychromatic image. Primary colors here can be for example the colors red, green and blue. However, other primary colors are also possible, e.g. cyan, magenta and yellow. In addition, in principle a color space can also comprise more or fewer than three primary colors, and so more or fewer than three color channels are then present. In the context of the present description, moreover, the situation when a monochromatic image is generated is also intended to be encompassed by reference to a color channel. The color channel then determines the color of the monochromatic image.

Each color channel of a polychromatic image generator that is to be transferred by the light-guiding arrangement is typically formed by a specific wavelength range having a spectral maximum, the wavelength of which defines the primary color of the color channel. In this case, each wavelength range has a certain spectral width, wherein dispersion in the material of the optical waveguide for each color channel results in different angles of reflection of the light in the wavelength range depending on the wavelength of the light. Since the light-guiding arrangement is optimized only for one wavelength in each wavelength range (typically for the wavelength that defines the primary color of the color channel, although that is not mandatory), the remaining wavelengths in the wavelength range are not reflected with the optimum angle of reflection. Furthermore, in the case where the imaging beam path is coupled into the optical waveguide and/or the imaging beam path is coupled out of the optical waveguide by means of diffraction gratings, the diffraction gratings of a color channel that are used for input coupling and/or output coupling are optimized in each case to a specific wavelength in the corresponding wavelength range, such that deviating wavelengths from the wavelength range are coupled out in a slightly different direction. Both effects have the consequence that for a color channel, during imaging, not all wavelengths in the associated wavelength range are focused to the same point. One measure of how well a point of an original image is focused to a point again in the image is the point spread function (PSF). The full width at half maximum of said point spread function increases on account of the above-described wavelength-dependent dispersion and diffraction for each color channel. This results in a reduced resolution of the image generated on the basis of the original image, and in a loss of contrast in this image.

The device for reducing the spectral bandwidth of the color channels counteracts the widening of the point spread function for each color channel. An imaging optical unit having a light-guiding arrangement according to the invention can be configured in this respect such that each color channel is reduced to a narrow spectral range around the respective spectral maximum of a wavelength range of the polychromatic image generator. With the aid of the light-guiding arrangement according to the invention, the reduction of the spectral bandwidth of the color channels for each color channel prevents the transfer of those wavelengths of the wavelength range assigned to said color channel which contribute most to the deterioration in the imaging quality.

In the case where the color channels of an imaging optical unit are optimized to the wavelengths of the spectral maxima of the wavelength ranges of the polychromatic image generator, the wavelengths of a wavelength range contribute to the deterioration in the image quality all the more, the further away they are from the spectral maximum. The further the spectral bandwidth is reduced, i.e. the narrower the spectral range of a color channel becomes, the more the imaging quality of the imaging optical unit improves, therefore. However, intensity in the imaging beam path is also lost as a result of the reduction of the spectral bandwidth of the color channels. The extent to which the spectral bandwidth of the color channels is expediently reduced with the aid of the device for reducing the spectral bandwidth is therefore generally a compromise between the desired intensity of the image and the desired imaging quality. If a very high imaging quality is desired, the spectral bandwidth of the color channels is greatly reduced, although a considerable loss of intensity also occurs. However, such a loss of intensity can possibly be compensated for by increasing the luminous intensity of the display. If the main emphasis is on the intensity of the image generated by means of the imaging optical unit, the reduction of the spectral bandwidth of the color channels will turn out to be smaller. Therefore, the extent to which the spectral bandwidth is reduced will typically depend on the respective application.

Although the present invention can already advantageously find application in the case of a polychromatic imaging if at least two color channels are present, it will typically be used in imaging optical units having three color channels, for example in imaging optical units having a red, a green and a blue color channel. However, the light-guiding arrangement according to the invention can also be used in imaging optical units for transferring more than three color channels.

Although the present invention is advantageous in particular in the context of a polychromatic imaging, it enables an improvement in the imaging quality in the context of a monochromatic imaging, too, if the image generator for the monochromatic imaging emits with a large spectral bandwidth around the wavelength chosen for the monochromatic imaging. The invention therefore makes it possible to use a broadband image generator in the case of a monochromatic imaging.

The device for reducing the spectral bandwidth of the color channel or color channels can be integrated into the optical waveguide. In this case, the light-guiding arrangement can be configured particularly compactly. Alternatively, there is also the possibility for the device for reducing the spectral bandwidth of the color channel or color channels to be a reducing element, e.g. in the form of a spectral filter element, disposed upstream or downstream of the optical waveguide. This makes it possible, in particular, to prevent the device for reducing the spectral bandwidth from altering the color perception of the surroundings upon viewing through the optical waveguide. However, there is also the possibility of the device for reducing the spectral bandwidth of the color channel or color channels partly being integrated into the optical waveguide and partly being embodied as a reducing element, e.g. in the form of a spectral filter element, disposed upstream or downstream of the optical waveguide. By way of example, for one color channel the device for reducing the spectral bandwidth can be integrated into the optical waveguide, whereas for the other color channel the device for reducing the spectral bandwidth is embodied as a reducing element disposed upstream or downstream of the optical waveguide. Finally, there is also the possibility, for at least one color channel or for each color channel, of a device for reducing the spectral bandwidth that is integrated into the optical waveguide and a device for reducing the spectral bandwidth that is configured in the form of a reducing element disposed upstream or downstream of the optical waveguide being combined with one another in such a way that the reduction of the spectral bandwidth of a color channel is achieved by the interaction of the element integrated into the optical waveguide with the reducing element disposed upstream or downstream of the optical waveguide.

The device for reducing the spectral bandwidth of the color channel or color channels can comprise one or more transmission filters, whether in the form of one or more transmission filters integrated into the optical waveguide and/or in the form of one or more transmission filters disposed upstream or downstream of the optical waveguide. The at least one transmission filter constitutes a spectral filter that allows only a specific wavelength range to pass through it. It can be embodied in particular as an absorption filter or as an interference filter. If the transmission filter is integrated into the optical waveguide, there is the possibility, in particular, of the at least one transmission filter being realized by an optical waveguide entrance surface provided with transmission filter properties and/or an optical waveguide exit surface provided with transmission filter properties. In this case, the optical waveguide entrance surface is that surface through which the imaging beam path enters the optical waveguide, and the optical waveguide exit surface is that surface through which the imaging beam path emerges from the optical waveguide. Since the optical waveguide entrance surface typically lies outside the field of view of a user of smartglasses provided with the optical waveguide or at least at the edge of the field of view to an extent such that a color distortion of ambient light passing through the optical waveguide is not perceived to be disturbing, equipping the optical waveguide entrance surface with transmission filter properties affords the advantage over equipping the optical waveguide exit surface with transmission filter properties that the color perception when looking at the surroundings is not distorted.

In addition or as an alternative to the at least one transmission filter, the device for reducing the spectral bandwidth of the color channel or color channels can comprise at least one spectrally selectively reflective element. Such an element can be embodied for example as a dichroically reflective element or as a reflective element that absorbs specific wavelengths.

The device for reducing the spectral bandwidth of the color channel or color channels can be realized as at least one coating, of at least one part of the optical waveguide or of an element disposed upstream or downstream of the optical waveguide. In this way, there is no need for an additional transmissive or reflective element in the beam path of the optical waveguide arrangement. Absorption and/or interference layers can be used in this case.

In the light-guiding arrangement according to certain embodiments, the device for reducing the spectral bandwidth of the color channel or color channels can comprise at least one narrowband filter, i.e. one narrowband spectral filter, and/or at least one narrowband spectrally selectively reflective element. In particular, a narrowband filter or a narrowband spectrally selectively reflective element can be present for each color channel. The narrowband filter or respectively the narrowband spectrally selectively reflective element would then e.g. in each case transmit the wavelength defining the primary color of the respective color channel and a wavelength range directly adjacent to said wavelength and block all other wavelengths. The chosen width of the wavelength range depends on the desired imaging quality, on the one hand, and on the desired intensity of the transmitted light, on the other hand. The narrower the wavelength range is chosen to be, the more the imaging quality improves, but at the expense of the intensity of the transmitted light. In principle here there is also the possibility of using a single narrowband filter or respectively a single narrowband spectrally selectively reflective element, which for each color channel transmits or respectively reflects a narrow spectral range around the wavelength defining the primary color of the respective color channel. In this way, the reduction of the bandwidth of a plurality of color channels can be realized with a single transmission filter or respectively a single spectrally selectively reflective element.

In addition or as an alternative to at least one narrowband filter or at least one narrowband selectively reflective element, the device for reducing the spectral bandwidth of the color channel or color channels can comprise at least:
two broadband filters,
two broadband spectrally selectively reflective elements or
one broadband filter and one broadband spectrally selectively reflective element,
   which each transfer the wavelength defining the primary color of a color channel and a wavelength range adjacent to said wavelength, wherein the wavelength ranges differ from one another.

In the context of the present description, a broadband filter should be understood to mean a transmission filter which transmits a part of the spectrum of a color channel which is bounded only on one side (e.g. a transmission filter which transmits only short-wave light or only long-wave light of the spectrum of a color channel), or a transmission filter which transmits at least half of the spectrum of a color channel. Accordingly, in the context of the present description, a broadband spectrally selectively reflective element should be understood to mean a reflective element which reflects a part of the spectrum which is bounded only on one side (e.g. an element which reflects only short-wave light or only long-wave light of the spectrum of a color channel), or a reflective element which causes at least half of the spectrum of a color channel to be reflected. The two broadband filters or the two broadband spectrally selectively reflective elements or the broadband filter and the broadband spectrally selectively reflective element then jointly bring about a reduction of the spectral bandwidth of the color channel or color channels. In this case, in principle there is the possibility of at least two broadband filters or at least two broadband spectrally selectively reflective elements or at least one broadband filter and one broadband spectrally selectively reflective element being present for each color channel. However, there is also the possibility of two broadband filters or two broadband spectrally selectively reflective elements or one broadband filter and one broadband spectrally selectively reflective element in each case jointly bringing about a reduction of the spectral bandwidth for more than one color channel. A broadband filter or respectively a broadband spectrally selectively reflective element is generally simpler to produce than a narrowband filter or respectively a narrowband selectively reflective element.

In the light-guiding arrangement according to certain embodiments, the optical waveguide can be a spectacle lens, in particular. Such a spectacle lens can advantageously be used in smartglasses.

An imaging optical unit according to certain embodiments for forming a virtual image of an original image represented on an image generator comprises a light-guiding arrangement according to the invention and at least one imaging optical element for forming an image of the original image. However, the imaging optical unit can also comprise a plurality of imaging optical elements, wherein these imaging optical elements then jointly form an image of the original image. In this case, the imaging optical unit can comprise at least one imaging optical element integrated into the optical waveguide. Additionally or alternatively, it can comprise at least one imaging optical element disposed upstream or downstream of the optical waveguide. In the latter case, the device for reducing the spectral bandwidth that is included in the light-guiding arrangement can be wholly or partly integrated into the imaging optical element disposed upstream or downstream.

The advantages in respect of the imaging quality that are achievable with regard to the light-guiding arrangement according to the invention can be realized in certain embodiments with the imaging optical unit according to the invention. Therefore, reference is made to the explanations concerning the light-guiding arrangement according to the invention.

A head mounted display according to certain embodiments, which can be smartglasses, in particular, comprises an image generator for representing an original image and an imaging optical unit according to the invention for forming a virtual image of the original image represented on the image generator. On account of the use of an imaging optical unit according to the invention, the head mounted display according to the invention makes it possible to realize the formation of a polychromatic virtual image with high imaging quality.

The invention in certain embodiments provides a method for improving the imaging quality of an imaging optical unit when transferring at least one color channel having a spectral maximum and a spectral bandwidth, wherein the at least one color channel is transferred by means of a light-guiding arrangement of the imaging optical unit. According to the invention, the spectral bandwidth of the at least one color channel is reduced during the transfer of the at least one color channel by the light-guiding arrangement. In particular, in the context of the method according to the invention, at least one first color channel and one second color channel are transferred, which have a respective different spectral maximum and a respective spectral bandwidth, wherein the spectral bandwidth of the color channels is reduced during the transfer of the color channels by the light-guiding arrangement. The reduction of the spectral bandwidth of the color channel or color channels during the transfer by the light-guiding arrangement makes it possible to increase the imaging quality of the imaging optical unit when generating a virtual image of an original image, as has been described with regard to the light-guiding arrangement according to the invention. Therefore, reference is made to the explanations concerning the light-guiding arrangement according to the invention.

In order to compensate for distortions in the images present at the wavelengths of the spectral maxima, said distortions being generated during the transfer of the respective color channels by the optical system, the original images on which the imaging is based can be represented on a display in each case with a distortion corresponding to the inverse of the distortion induced by the transfer of the respective color channel. Such a distorted representation on the display is also referred to as chromatic precorrection.

Further features, properties and advantages of the present invention will become apparent from the following description of exemplary embodiments with reference to the accompanying figures.

### BRIEF DESCRIPTION OF THE DRAWINGS

FIG. 1 shows one example of smartglasses.

FIG. 2 shows, in a schematic illustration, one example of the essential optical components of smartglasses.

FIG. 3 schematically shows the spectral bandwidth of the color channels of a polychromatic display.

FIG. 4 shows the transmission properties of the optical waveguide entrance surface of the optical waveguide of a light-guiding arrangement in accordance with a first exemplary embodiment.

FIG. 5 shows the transmission properties of the optical waveguide entrance surface of the optical waveguide of a light-guiding arrangement in accordance with a second exemplary embodiment.

FIG. 6 shows the reflection properties of a first reflective surface of the light-guiding arrangement of the second exemplary embodiment.

FIG. 7 shows the reflection properties of a second reflective surface of the light-guiding arrangement of the second exemplary embodiment.

FIG. 8 shows the transmission properties of the optical waveguide entrance surface of the optical waveguide of a light-guiding arrangement in accordance with a third exemplary embodiment.

FIG. 9 shows the reflection properties of a first reflective surface of the light-guiding arrangement of the third exemplary embodiment.

FIG. 10 shows the reflection properties of a second reflective surface of the light-guiding arrangement of the third exemplary embodiment.

FIG. 11 shows smartglasses with a light-guiding arrangement in accordance with a fourth exemplary embodiment.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

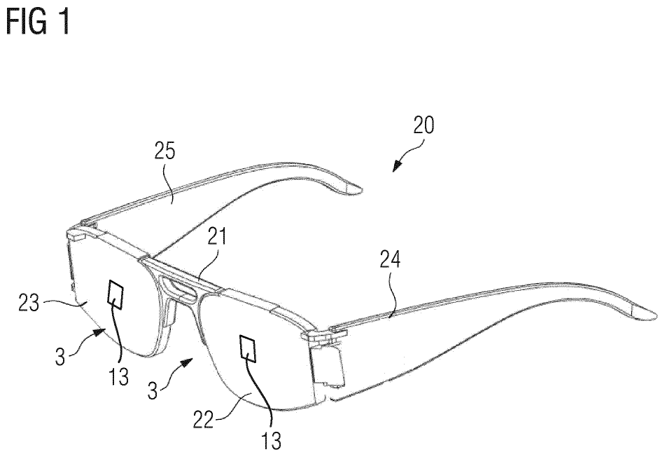

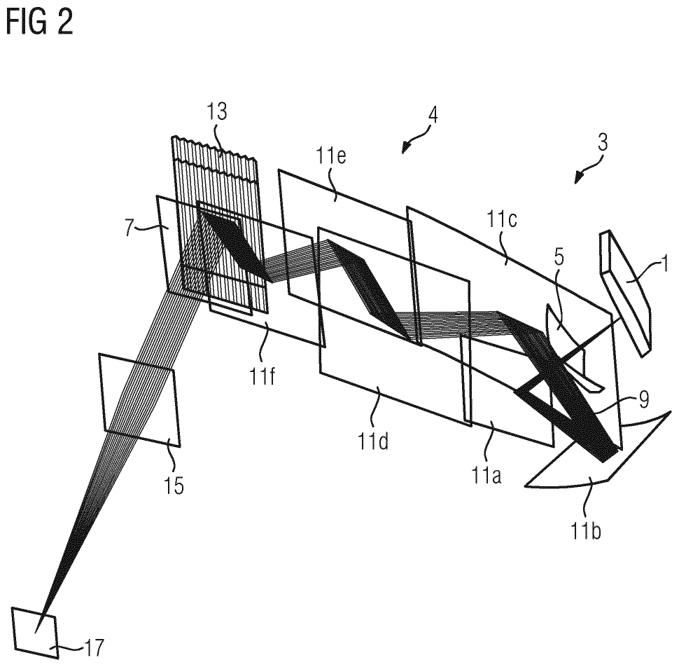

A first exemplary embodiment of smartglasses with a light-guiding arrangement according to the invention is described below with reference to FIGS. 1 to 4. In this case, FIG. 1 shows the smartglasses and FIG. 2 shows the essential optical elements of a light-guiding arrangement 3 of the smartglasses. Furthermore, FIG. 2 illustrates a display 1 and—highly schematically—the eye lens 15 and the retina 17 of a user of the smartglasses.

FIG. 1 shows one exemplary embodiment of smartglasses 20. The smartglasses comprise a spectacle frame 21, into which two spectacle lenses 22 and 23 are mounted. Displays (not illustrated in FIG. 1) are arranged in the spectacle earpieces, said displays displaying original images that are intended to be imaged onto the retina of the user of the smartglasses by means of an imaging optical unit of the smartglasses 20. In the present exemplary embodiment, the imaging optical unit of the smartglasses 20 is formed by the spectacle lenses 22 and 23, which simultaneously serve as optical waveguides. However, the imaging optical unit can also comprise optical elements outside the spectacle lenses. Such elements would be arranged in particular between the spectacle earpieces 24, 25 and the spectacle lenses 22, 23.

The spectacle lenses 22, 23 of the smartglasses are in each case part of a light-guiding arrangement of the smartglasses 20 or form said light-guiding arrangement. The essential optical elements of such a light-guiding arrangement 3 are illustrated in FIG. 2. Each light-guiding arrangement 3 is assigned a polychromatic display 1 on which a polychromatic original image can be displayed. Each light-guiding arrangement 3 comprises an optical waveguide 4 having an optical waveguide entrance surface 5 and an optical waveguide exit surface 7. A beam 9 emanating from the original image displayed on the display 1 enters the optical waveguide 4 via the optical waveguide entrance surface 5 and in said optical waveguide is reflected multiply at a number of reflective surfaces 11a to 11f and guided by means of these reflections to a transparent or at least partly transparent output coupling structure 13. With the aid of the output coupling structure 13, which is embodied as a reflective Fresnel structure in the present exemplary embodiment, the beam 9 is finally coupled out through the optical waveguide exit surface 7 in the direction toward the eye lens 15, which finally focuses the beam 9 onto the retina 17. In this case, the reflective Fresnel structure is formed by a plurality of inclined partly reflective surfaces that form a structure like a sawtooth in profile. By virtue of the segmentation, the partly reflective surface forming the output coupling structure 13 can be configured with a small depth. Instead of a reflective Fresnel structure, however, unsegmented mirrors or else diffraction gratings or holographic optical elements (HOE) can also be used for the purpose of output coupling. The input coupling can likewise be effected by way of diffraction gratings or HOEs. The output coupling structure can be arranged at the side of the optical waveguide 4 facing away from the eye lens 15, as illustrated in FIG. 2. In principle, however, it can also be arranged at the side of the optical waveguide 4 facing the eye lens 15 and in this case can in particular also be integrated into the optical waveguide exit surface 7. In this case, the output coupling structure would have a refractive effect instead of a partly reflective effect and would guide the beam path 9 by means of refraction in the direction toward the eye lens 15. Partly reflective output coupling structures are described e.g. in US 2012/0002294 A1, and refractive output coupling structures e.g. in DE 10 2015 117 557 A1. Diffraction gratings as output coupling structures are described in US 2006/0126181 A1 and US 2010/0220295 A1. Therefore, reference is made to the cited documents with regard to the possible configurations of the output coupling structure 13. Diffractive output coupling can be effected either by an output coupling structure 13 arranged at the side of the optical waveguide 4 facing away from the eye lens 15, or by an output coupling structure arranged at the side of the optical waveguide 4 facing the eye lens 15.

In the exemplary embodiment illustrated in FIGS. 1 and 2, each optical waveguide 4 is formed by a spectacle lens 22, 23. The reflective surfaces 11a and 11c to 11f are situated at the inner surface—facing the eye lens 15—and the outer surface—facing away from the eye lens 15—of the respective spectacle lens 22, 23. In this case, the geometry and the arrangement of the reflective surfaces 11a to 11f are chosen such that at the reflective surfaces 11c, 11d, 11e and 11f total reflection takes place at the interface between the respective spectacle lens 22, 23 and the surrounding medium, generally air. The condition for the occurrence of total reflection is known to a person skilled in the art and is not explained any further at this point. Since the total reflection takes place internally in the spectacle lenses, it is also called total internal reflection. Since light is guided internally in the spectacle lens by total internal reflection and the output coupling structure 13 is embodied as at least partly transparent, the view of the surroundings is not impeded or only minimally impeded. In particular, the impeding of the view of the surroundings can be minimized by means of suitable configurations of the output coupling structure 13. In principle, however, an optical waveguide 4, i.e. a spectacle lens 22, 23, can also be configured such that the reflection does not take place by means of total reflection. In this case, the optical waveguide 4 has reflective coatings, but the coatings are chosen as far as possible such that they have an angularly selective effect and thus block light passing through the optical waveguide 4 from the surroundings as little as possible.

Instead of being embodied in the form of a spectacle lens 22, 23 as in the present exemplary embodiment, in principle the optical waveguide 4 can also be embodied in the form of a visor or the like. When smartglasses are mentioned in the context of the present invention, this term can therefore also encompass head mounted displays having visor-like structures, even if the latter are not explicitly mentioned.

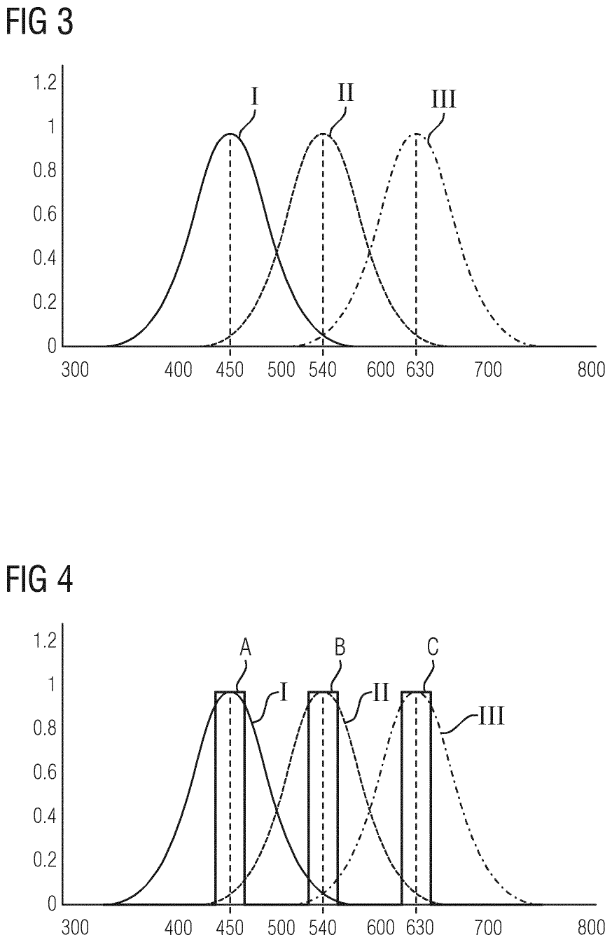

As mentioned, polychromatic image generators 1 are used in the smartglasses 20 according to the invention. A polychromatic image generator typically emits in three wavelength ranges, each representing a color channel. A wavelength range concentrating on the blue spectral range, a wavelength range concentrating on the green spectral range and a wavelength range concentrating on the red spectral range are customary. FIG. 3 shows the spectral emission characteristic of a typical polychromatic display. In the latter, each image point has a blue light source, a green light source and a red light source. In the present exemplary embodiment, the blue light source emits light with a wavelength range having a maximum at approximately 450 nm, the green light source emits light having a maximum at approximately 540 nm, and the red light source emits light having a maximum at approximately 630 nm. Each light source furthermore also emits with wavelengths adjacent to the maximum, and so each light source has a spectral bandwidth. The spectrum I of the blue light source, the spectrum II of the green light source and the spectrum III of the red light source are illustrated in FIG. 3, the intensities of the maxima being normalized to one for the sake of better comparability. The spectra I to III represent the three color channels of the display.

The light-guiding arrangement 4 of the smartglasses 20 is optimized to the transfer of those wavelengths of the individual color channels which correspond to the maxima of the color channels. In the present example this means that the light-guiding arrangement is optimized to transferring light with a wavelength of 450 nm, with a wavelength of 540 nm and a wavelength of 630 nm. The reflections and/or in other embodiments possibly refractions and/or in other embodiments possibly diffractions at the individual elements of the light-guiding arrangement are configured here such that light rays having the wavelengths 450 nm, 540 nm, and 630 nm that emanate from an image point of the original image—from different image points of the display in the case of a chromatic precorrection—are focused to one and the same point on the retina.

On account of dispersion occurring in the optical waveguide, light rays having different wavelengths are refracted differently, however, upon entering the optical waveguide 3 and upon emerging from the optical waveguide 3. In particular the refraction upon passing through the optical waveguide entrance surface 5 results, depending on the wavelength of the light, in different directions of the refracted light rays in the optical waveguide 3 and thus in light rays with different wavelengths impinging on the reflective surfaces 11a to 11f at different angles, which results in different distortions in the color images transferred by the different color channels, here the blue, green and red images. As a result, light rays emanating from an image point of the display are not combined at the same point on the retina for all the colors. In the context of the optimization of the light-guiding arrangement 4, it is possible to counter this effect for individual wavelengths such as e.g. the wavelengths of the maxima of the color channels e.g. by separating the color channels from one another in the optical waveguide, e.g. by means of the color channels being guided through different sections of the optical waveguide 3 and being combined again only when they emerge from the optical waveguide. Additionally or alternatively, for individual wavelengths such as e.g. the wavelengths of the maxima of the color channels, it is possible to effect a chromatic precorrection in the context of the representation of the original image on the display. In the case of a chromatic precorrection, mutually corresponding image points of the color images are not represented by the same image point of the display. As a result, it is possible to take account of distortions of the color images in the original image, said distortions being generated during the transfer of the respective color channels by the optical system. For this purpose, the color original images (here the original image at 450 nm, the original image at 540 nm and the original image at 630 nm) are represented on the display with generally different distortions which respectively correspond to the inverse of the distortion induced by the transfer of the respective color channel and which therefore compensate for the distortions occurring in the color channels. As a result, therefore, the mutually corresponding image points of the color images of the original image that are represented by different image points of the display are focused to the same point on the retina.

For those wavelengths of a color channel which deviate from the wavelength of its maximum, despite the optimization of the light-guiding arrangement 4 and/or despite the chromatic precorrection, the problem associated with dispersion still persists, however, which has the consequence that each color channel contains light rays with wavelengths deviating from the wavelength of its maximum, which light rays are not focused to the same point on the retina as light rays with the wavelength of the maximum, the result of which is a loss of resolution and loss of sharpness in the generated image. In the case of diffractive input and/or output coupling of the light into and/or out of the optical waveguide 3, the wavelength dependence of the angle of diffraction additionally also results in different directions of propagation of light rays with different wavelengths, which likewise results in a loss of resolution and contrast in the generated image.

In order to counteract the loss of resolution and contrast, in the present exemplary embodiment, the optical waveguide entrance surface 5 is provided with a coating having a transmission characteristic such as is illustrated schematically in FIG. 4. The coating, which is realized by interfering layers in the present exemplary embodiment, forms a spectral filter having three narrowly delimited transmission ranges A, B, C. In the present exemplary embodiment, the spectral width of said transmission ranges is in each case limited to 20 nm and centered around the wavelength of the maximum of the respective imaging channel. Therefore, in the present exemplary embodiment, the first transmission range A extends from 440 to 460 nm, the second transmission range B extends from 530 to 550 nm and the third transmission range C extends from 620 to 640 nm. The remaining wavelengths are blocked by the coating of the optical waveguide entrance surface 5. It is evident that the coating of the optical waveguide entrance surface functions as a narrowband spectral filter with three narrowly delimited spectral transmission ranges. Such transmission filters can be realized with steep slopes and a transmissivity of the transmission ranges A, B, C of almost 100%. In the remaining ranges, such transmission filters have a transmissivity of close to 0.

Reducing the spectral bandwidth of the individual color channels with the aid of the coating applied to the optical waveguide entrance surface 5 masks out those wavelengths of the individual color channels which contribute most to the loss of resolution and contrast, which as a result improves the resolution and the contrast of the image generated on the retina.

In the present exemplary embodiment, the spectral filter described is realized by interfering layers of the optical waveguide entrance surface 5, and so it is a so-called interference filter. In an interference filter, those wavelengths which are intended to be blocked by the filter are reduced by destructive interference. However, a spectral filter can also be realized as an absorption filter. In the case of such a filter, the reduction of the undesired wavelengths is not effected by destructive interference, but rather by absorption of the light with the corresponding wavelengths in the filter layer.

A second exemplary embodiment for the smartglasses according to the invention is explained below with reference to FIGS. 5 to 7. The structural design of the second exemplary embodiment corresponds to the structural design of the first exemplary embodiment such as has been described with reference to FIG. 1 and FIG. 2. With regard to the structural elements, therefore, reference is made to the elements shown in FIGS. 1 and 2.

In contrast to the first exemplary embodiment, in the second exemplary embodiment, the optical waveguide entrance surface 5 is provided with a coating having a broad transmission range (see FIG. 5). The transmission range of the coating covers a large part of the visible spectral range, namely the range from 440 to 640 nm. All wavelengths in this range are transmitted with virtually no impediment of the layer, and the remaining wavelengths are blocked to the greatest possible extent by the layer.

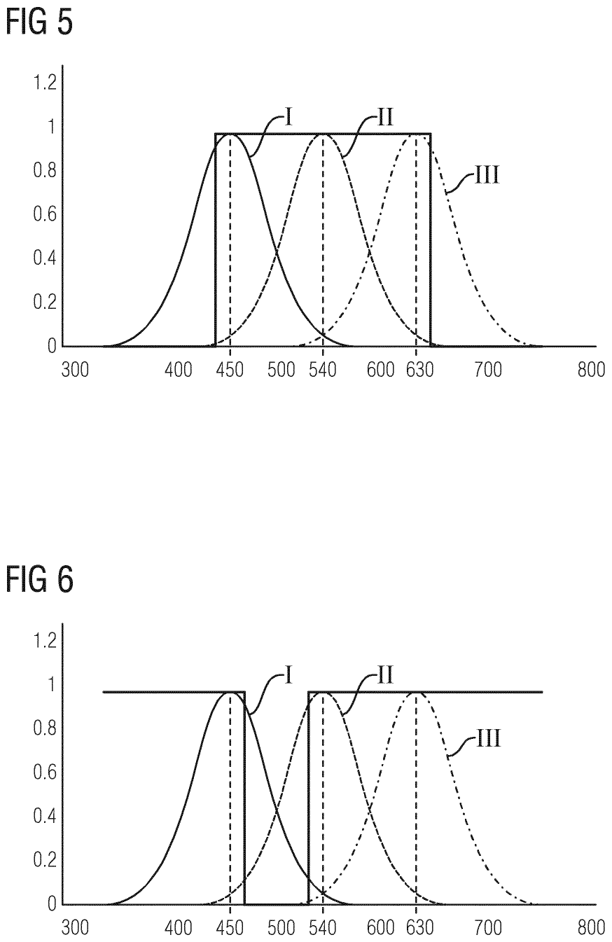

In the present second exemplary embodiment, a coating is also applied to the reflective surface 11a. Said coating suppresses a reflection in the wavelength range of between 460 and 530 nm (see FIG. 6). The suppression of the reflection can be achieved by means of interference layers or by means of absorption layers. As a result, the first reflective surface 11a only reflects light with wavelengths of <460 nm and >530 nm.

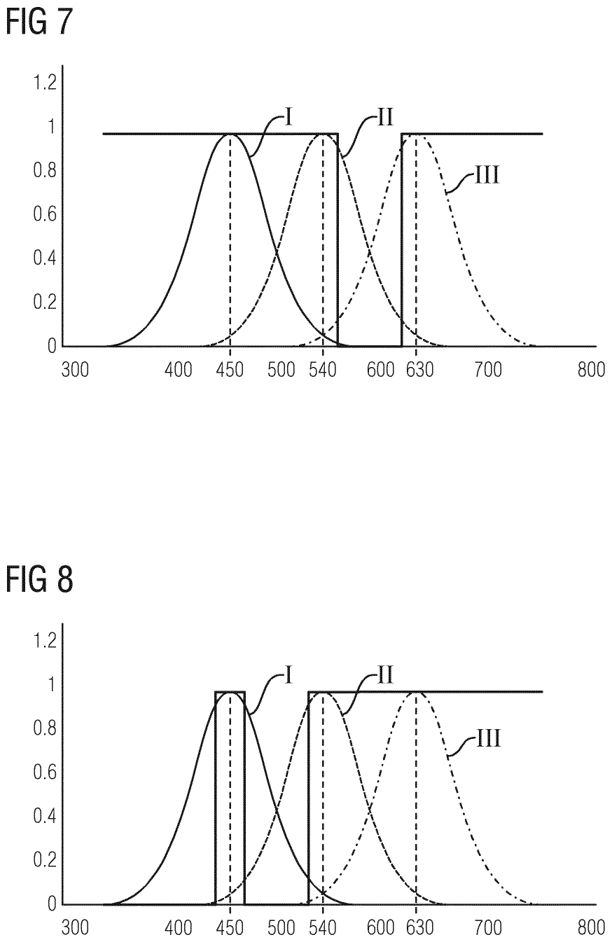

Furthermore, in the present exemplary embodiment, a coating is also applied on the reflective surface 11b. Said coating suppresses a reflection in the wavelength range of between 550 and 620 nm (see FIG. 7). As a result, the first reflective surface 11b only reflects light with wavelengths of <550 nm and >620 nm. The coating on the reflective surface 11b can also be realized by means of interference layers or absorption layers.

The interaction of the coating applied to the optical waveguide entrance surface 5, of the coating applied to the reflective surface 11a and of the coating applied to the reflective surface 11b blocks the transfer of wavelengths outside the wavelength ranges of 440 to 460 nm, 530 to 550 nm and 620 to 640 nm by the light-guiding arrangement. As a result, therefore, only the spectral range of 440 to 460 nm is transferred for the blue color channel, the spectral range of 530 to 550 nm for the green color channel, and the spectral range of 620 to 640 nm for the red color channel. The resulting reduction of the spectral bandwidth of the color channels leads to an improvement in resolution and contrast in the image that arises on the retina.

A third exemplary embodiment for smartglasses according to the invention is described below with reference to FIGS. 8 to 10. In this exemplary embodiment, the same elements as in the second exemplary embodiment are provided with coatings. Just the coatings differ from those in the second exemplary embodiment.

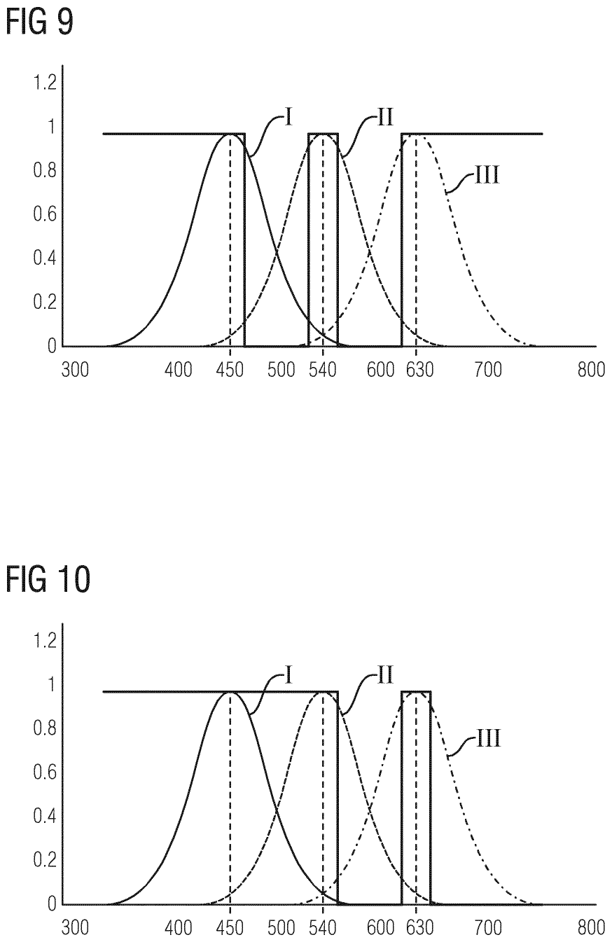

In the third exemplary embodiment, the optical waveguide entrance surface 5 has applied to it a coating which blocks all wavelengths below 440 nm and all wavelengths in the range of 460 to 530 nm and transmits all remaining wavelengths (see FIG. 8). On the reflective surface 11a a coating is applied which suppresses the reflection in the wavelength range of between 460 nm and 530 nm and in the wavelength range of between 550 nm and 620 nm, but in contrast does not suppress the reflection of the remaining wavelengths (see FIG. 9), and on the reflective surface 11b a coating is applied which suppresses a reflection in the wavelength range of between 550 nm and 620 nm and a reflection of all wavelengths above 640 nm, but in contrast does not suppress the reflection of the remaining wavelengths (see FIG. 10). As a result of the interaction of the three coatings, the light-guiding arrangement of the third exemplary embodiment offers for each color channel in each case only a narrow transmission range with a width of 20 nm, said transmission range being centered around the primary color of the respective color channel. As a result, therefore, only the spectral range of 440 to 460 nm is thus transferred for the blue color channel, the spectral range of 530 to 550 nm for the green color channel, and the spectral range of 620 to 640 nm for the red color channel. As in the other exemplary embodiments, the coatings of the third exemplary embodiment can be realized by means of interference layers or absorption layers.

In exemplary embodiments 1 to 3, at least one of the reflective surfaces 11a to 11f and/or the optical waveguide entrance surface 5 and/or the surfaces of the output coupling structure 13 and/or the optical waveguide exit surface 7 have/has imaging properties individually or jointly. If one surface has imaging properties individually, this should be understood to mean that the corresponding surface is configured in such a way that it alone in interaction with the eye lens 17 generates the image on the retina 19. If a plurality of surfaces have imaging properties jointly, this should be understood to mean that the image on the retina is generated by the interaction of these surfaces and the eye lens 17.

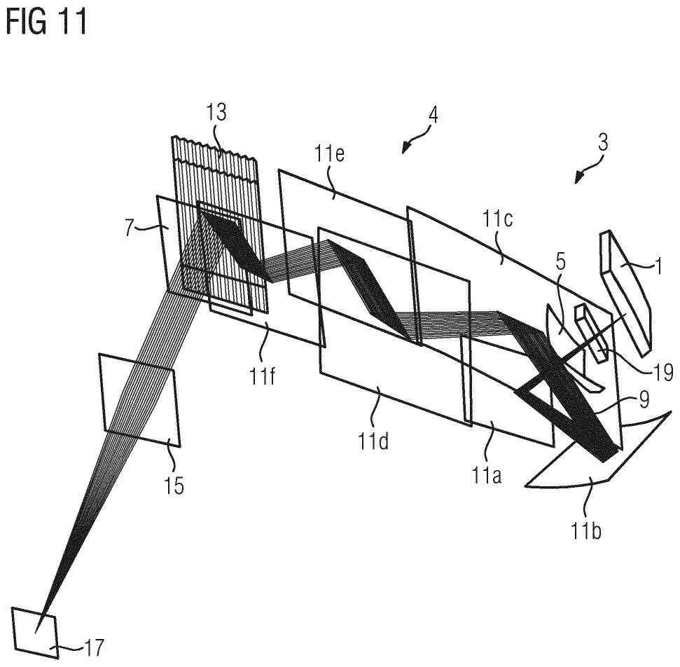

A fourth exemplary embodiment for smartglasses according to the invention is illustrated in FIG. 11. Elements of the fourth exemplary embodiment which correspond to elements of the first exemplary embodiment are designated in FIG. 11 by the same reference signs as in FIG. 2 and will not be explained again in order to avoid repetition. In actual fact the sole difference between the fourth exemplary embodiment and the first exemplary embodiment is the difference that the transmission behavior shown in FIG. 4 is not realized by means of a coating of the optical waveguide entrance surface 5, but rather by means of a spectral filter element 19 arranged between the image generator 1 and the optical waveguide entrance surface 5, said spectral filter element serving as a reducing element for reducing the spectral bandwidth of the color channels. Said spectral filter element 19, which can be embodied as an interference filter or as an absorption filter, has a transmission characteristic as shown in FIG. 4. This transmission characteristic can in particular also be achieved by virtue of the coating that is applied to the optical waveguide entrance surface 5 in the first exemplary embodiment being applied to a separate transparent element, which is then arranged as spectral filter element 19 between the display 1 and the optical waveguide entrance surface 5.

As in the first three exemplary embodiments, in the fourth exemplary embodiment, too, at least one of the reflective surfaces 11a to 11f and/or the optical waveguide entrance surface 5 and/or the surfaces of the output coupling structure 13 and/or the optical waveguide exit surface 7 can have imaging properties individually or jointly. Additionally or alternatively, the spectral filter element 19 can have imaging properties by itself or together with at least one of the elements mentioned above.

The present invention has been described in detail on the basis of exemplary embodiments for explanatory purposes. A person skilled in the art recognizes, however, that it is possible to depart from these exemplary embodiments, without in so doing departing from the teaching of the invention. By way of example, a person skilled in the art recognizes that even though three color channels are described in each of the exemplary embodiments, the invention can also be realized with fewer or more than three color channels. In particular, the invention can also be realized with just one color channel. This opens up e.g. the possibility of using image generators with a broad emission spectrum for generating monochromatic images having high resolution and high contrast. Moreover, a person skilled in the art also recognizes that a light-guiding arrangement according to the invention can also be used in head mounted displays which are not embodied as smartglasses, i.e. which do not enable direct perception of the surroundings. Therefore, the present invention is not intended to be restricted to the configurations described with reference to the exemplary embodiments, rather the intention is for restriction only to be effected by the claims.

### LIST OF REFERENCE SIGNS

1 Display
3 Light-guiding arrangement
4 Optical waveguide
5 Optical waveguide entrance surface
7 Optical waveguide entrance surface
9 Beam
11a-f Reflective surfaces
13 Output coupling structure
15 Eye lens
17 Retina
19 Spectral filter element
20 Smartglasses
21 Spectacle frame
22 Spectacle lens
23 Spectacle lens
24 Spectacle earpiece
25 Spectacle earpiece

1-19. (canceled)

20. A light-guiding arrangement, comprising:
an optical waveguide that transfers at least one color channel having a spectral maximum and a spectral bandwidth; and
a device for reducing the spectral bandwidth of the at least one color channel.

21. The light-guiding arrangement of claim 20, wherein the optical waveguide is configured to transfer a first color channel and a second color channel, wherein each of the first and second color channels have a respective spectral maximum and a respective spectral bandwidth, the positions of the spectral maxima of the color channels in the spectrum differ from one another, and wherein the device for reducing the spectral bandwidth of the at least one color channel reduces the spectral bandwidth of each of the first and second color channels.

22. The light-guiding arrangement of claim 20, wherein the device for reducing the spectral bandwidth of the at least one color channel is integrated into the optical waveguide.

23. The light-guiding arrangement of claim 20, wherein the device for reducing the spectral bandwidth of the at least one color channel comprises a reducing element disposed upstream or downstream of the optical waveguide.

24. The light-guiding arrangement of claim 20, wherein the device for reducing the spectral bandwidth of the at least one color channel comprises at least one transmission filter.

25. The light-guiding arrangement of claim 24, wherein the at least one transmission filter comprises an optical waveguide entrance surface provided with transmission filter properties.

26. The light-guiding arrangement of claim 20, wherein the device for reducing the spectral bandwidth of the at least one color channel comprises at least one spectrally selectively reflective element.

27. The light-guiding arrangement of claim 20, wherein the device for reducing the spectral bandwidth of the at least one color channel comprises a coating disposed on at least a portion of the optical waveguide or of a reducing element disposed upstream or downstream of the optical waveguide.

28. The light-guiding arrangement of claim 20, wherein the device for reducing the spectral bandwidth of the at least one color channel comprises at least one narrowband filter and/or at least one narrowband spectrally selectively reflective element.

29. The light-guiding arrangement of claim 20, wherein the device for reducing the spectral bandwidth of the at least one color channel comprises:
two broadband filters;
two broadband spectrally selectively reflective elements; or
one broadband filter and one broadband spectrally selectively reflective element, which jointly bring about a reduction of the spectral bandwidth of the at least one color channel.

30. The light-guiding arrangement of claim 20, wherein the optical waveguide is a spectacle lens.

31. An imaging optical unit for forming a virtual image of an original image represented on an image generator, comprising the light-guiding arrangement of claim 20 and at least one imaging optical element.

32. The imaging optical unit of claim 31, wherein the at least one imaging optical element is integrated into the optical waveguide.

33. The imaging optical unit of 31, wherein the at least one imaging optical element is disposed upstream or downstream of the optical waveguide, and wherein the device for reducing the spectral bandwidth of the at least one color channel is integrated wholly or partly into the imaging optical element disposed upstream or downstream.

34. A head mounted display, comprising:
an image generator for representing an original image; and
the imaging optical unit of claim 31 to form a virtual image of the original image represented on the image generator.

35. The head mounted display of claim 34, wherein the head mounted display is configured as smartglasses.

36. A method for improving the imaging quality of an imaging optical unit when transferring at least one color channel having a spectral maximum and a spectral bandwidth, the method comprising:
transferring at least one color channel via a light-guiding arrangement of the imaging optical unit; and
reducing the spectral bandwidth of the at least one color channel during the transfer of the at least one color channel by the light-guiding arrangement.

37. The method of claim 36, further comprising:
transferring a second color channel having a respective different spectral maximum and a respective spectral bandwidth as comparted to the first color channel; and
reducing the spectral bandwidth of the second color channel during the transfer of the second color channel by the light-guiding arrangement.

38. The method of claim 36, wherein distortions in an image are present at wavelengths of the spectral maxima, said distortions being generated during the transfer of the respective color channels by the imaging optical unit, the method further comprising:
compensating for the distortions by generating inverse distortions of an original image at the wavelengths of the spectral maxima, said original image being represented on a display and taken as a basis for the imaging.
